(19) United States
(12) Patent Application Publication
(10) Pub. No.: US 2026/0235740 A1
(43) Pub. Date: Aug. 13, 2026

(54) CONTROL, CONTROL METHOD AND TIME-OF-FLIGHT DEVICE

(71) Applicant: Sony Semiconductor Solutions Corporation, Kanagawa (JP)

(72) Inventors: Mohamed BOUNOUAR, Basingstoke (GB); Maarten KUIJK, Basingstoke (GB)

(73) Assignee: Sony Semiconductor Solutions Corporation, Kanagawa (JP)

(21) Appl. No.: 19/153,609

(22) PCT Filed: Mar. 7, 2024
(86) PCT No.: PCT/EP2024/056020

§ 371 Date: Aug. 5, 2025

(30) Foreign Application Priority Data
Mar. 13, 2023 (EP) 23161519.6

(51) Int. Cl. G01S 7/4915; G01S 7/4911; G01S 7/4914; G01S 17/32

(52) U.S. Cl. CPC G01S 7/4915; G01S 7/4911; G01S 7/4914; G01S 17/32

(57) ABSTRACT

A control for a time-of-flight device is provided. The time-of-flight device includes a light source configured to emit a modulated light signal and a time-of-flight sensor comprising a plurality of time-of-flight circuitries. Each circuitry is configured to generate an avalanche signal representing a light detection event and to sample first and second demodulation signals, applied to respective input nodes, based on the avalanche signal to generate first and second output voltages representing distance information. The first and second demodulation signals are phase-shifted by 90 degrees. The control includes circuitry configured to control timing of the demodulation signals and the light emission of the light source, and to control acquisition of first and second frames, each including digital representations of the output voltages. A 180-degree phase shift is applied between the first and second frames in either the demodulation signals or the modulated light signal.

### TECHNICAL FIELD

The present disclosure generally pertains to a control and a control method for a time-of-flight device and to a time-of-flight device.

### TECHNICAL BACKGROUND

Generally, time-of-flight devices are known. For instance, direct time-of-flight (dToF) devices in which typically SPADs (Single Photon Avalanche Diode) are used to detect light events and the time-of-arrival is stored in a histogram which is read out. Based on the speed of light, the distance to objects can be calculated.

Another technology, known as indirect time-of-flight (iToF), is based on determining a phase shift of between light emission and light detection to obtain distance information. In iToF, the light detection is based on a demodulation signal typically applied to CAPD (Current Assisted Photonic Demodulator) pixels.

The International patent application publication WO 2022043480 A1 describes another type of ToF technology.

However, a ToF measurement may be impacted by non-ideal characteristics of the light detection and readout circuit such as leakage current, feedthrough, transistor offset, asymmetric behavior, etc.

Although there exist techniques for time-of-flight measurements, it is generally desirable to improve the existing techniques.

### SUMMARY

According to a first aspect the disclosure provides a control for a time-of-flight device,
the time-of-flight device including a light source configured to emit a modulated light signal and a time-of-flight sensor including a plurality of time-of-flight circuitries, each time-of-flight circuitry being configured to generate an avalanche signal representing a light detection event and to sample a first and a second demodulation signal applied to a first and a second input node, respectively, based on the avalanche signal to generate a first and a second output voltage representing distance information, the first and the second demodulation signal being phase shifted by 90° with respect to each other,
wherein the control comprises circuitry configured to:
control a timing of the first and second demodulation signal and a light emission of the light source; and
control the time-of-flight sensor to acquire a first and a second frame, each frame including a digital representation of the first and the second output voltage of at least a part of the plurality of time-of-flight circuitries, wherein the first and second demodulation signal or the modulated light signal is phase shifted by 180° between the first and the second frame.

According to a second aspect the disclosure provides a control method for a time-of-flight device,
the time-of-flight device including a light source configured to emit a modulated light signal and a time-of-flight sensor including a plurality of time-of-flight circuitries, each time-of-flight circuitry being configured to generate an avalanche signal representing a light detection event and to sample a first and a second demodulation signal applied to a first and a second input node, respectively, based on the avalanche signal to generate a first and a second output voltage representing distance information, the first and the second demodulation signal being phase shifted by 90° with respect to each other,
wherein the control method comprises:
controlling a timing of the first and second demodulation signal and a light emission of the light source; and
controlling the time-of-flight sensor to acquire a first and a second frame, each frame including a digital representation of the first and the second output voltage of at least a part of the plurality of time-of-flight circuitries, wherein the first and second demodulation signal or the modulated light signal is phase shifted by 180° between the first and the second frame.

According to a third aspect the disclosure provides a time-of-flight device, comprising:
a light source configured to emit a modulated light signal;
a time-of-flight sensor including a plurality of time-of-flight circuitries, each time-of-flight circuitry being configured to generate an avalanche signal representing a light detection event and to sample a first and a second demodulation signal applied to a first and a second input node, respectively, based on the avalanche signal to generate a first and a second output voltage, respectively, representing distance information, the first and the second demodulation signal being phase shifted by 90° with respect to each other; and
a control including circuitry configured to:
   control a timing of the first and second demodulation signal and a light emission of the light source; and
   control the time-of-flight sensor to acquire a first and a second frame, each frame including a digital representation of the first and the second output voltage of at least a part of the plurality of time-of-flight circuitries, wherein the first and second demodulation signal or the pulse-width modulated light signal is phase shifted by 180° between the first and the second frame.

According to a fourth aspect the disclosure provides a time-of-flight device, comprising:
a light source configured to emit a modulated light signal;
a time-of-flight sensor including:
   a plurality of time-of-flight circuitries, each time-of-flight circuitry including:
      a SPAD circuit configured to generate an event upon detection of a photon,
      a switch control circuit configured to generate, in response to the generated event, a first signal for sampling a demodulation signal and a second signal for including the sample into an average output,
      a first averaging demodulator, which has a first demodulation voltage applied at its input node, configured to sample the first demodulation signal in response to the first signal and to include the sample in its output voltage in response to the second signal to generate a first output voltage,
      a second averaging demodulator, which has a second demodulation voltage applied at its input node, configured to sample the second demodulation signal in response to the first signal and to include the sample in its output voltage in response to the second signal to generate a second output voltage,
      wherein the first and the second demodulation signal are phase shifted by 90° with respect to each other; and
a control including circuitry configured to:
   control a timing of the first and second demodulation signal and a light emission of the light source,
   control the time-of-flight sensor to acquire a first and a second frame, each frame including a digital representation of the first and the second output voltages of at least a part of the plurality of time-of-flight circuitries, wherein the first and second demodulation signal or the modulated light signal is phase shifted by 180° between the first and the second frame.

Further aspects are set forth in the dependent claims, the drawings and the following description.

### BRIEF DESCRIPTION OF THE DRAWINGS

Embodiments are explained by way of example with respect to the accompanying drawings, in which:

FIG. 1 schematically illustrates in a block diagram an embodiment of a time-of-flight device;

FIG. 2 schematically illustrates in a block diagram an embodiment of a time-of-flight sensor;

FIG. 3 schematically illustrates an embodiment of time-of-flight circuitry (a TOF receiver) with a SPAD circuit, a switch control circuit and two averaging demodulators driven by the switch control circuit;

FIG. 4 schematically illustrates transient signals of an operation of the time-of-flight circuitry of FIG. 3, thereby demonstrating the use of sine and cosine demodulation signals;

FIG. 5 schematically illustrates a zoom-in on some of the signals around the event at ninety-six nanoseconds of FIG. 4;

FIG. 6 schematically illustrates an embodiment of a time-of-flight measurement sequence;

FIG. 7 schematically illustrates an embodiment of an impact of a leakage current on a time-of-flight measurement;

FIG. 8 schematically illustrates an embodiment of a time-of-flight measurement sequence;

FIG. 9 schematically illustrates an embodiment of a time-of-flight measurement sequence;

FIG. 10 schematically illustrates an embodiment of a time-of-flight measurement sequence;

FIG. 11 schematically illustrates an embodiment of a time-of-flight measurement sequence; and

FIG. 12 schematically illustrates in a flow diagram an embodiment of a control method.

### DETAILED DESCRIPTION OF EMBODIMENTS

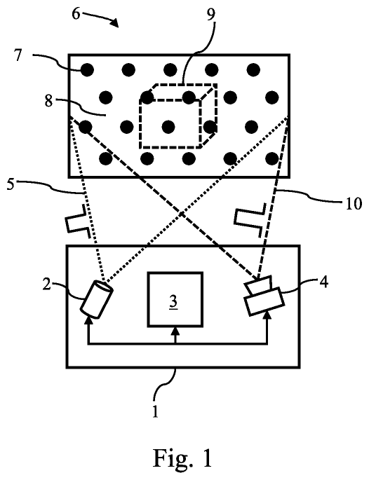

Before a detailed description of the embodiments under reference of FIG. 1 is given, general explanations are made.

As mentioned in the outset, generally, time-of-flight devices are known. For instance, direct time-of-flight (dToF) devices in which typically SPADs (Single Photon Avalanche Diode) are used to detect light events and the time-of-arrival is stored in a histogram which is read out. Based on the speed of light, the distance to objects can be calculated.

Another technology, known as indirect time-of-flight (iToF), is based on determining a phase shift of between light emission and light detection to obtain distance information. In iToF, the light detection is based on a demodulation signal typically applied to CAPD (Current Assisted Photonic Demodulator) pixels.

The International patent application publication WO 2022043480 A1 describes another type of ToF (time-of-flight) technology, which is used in some embodiments.

However, it has been recognized that a ToF measurement may be impacted by non-ideal characteristics of the light detection and readout circuit such as leakage current, feedthrough, transistor offset, asymmetric behavior, etc.

It has thus been recognized that the impact of the non-idealities, in particular the leakage current, on the ToF measurement should be mitigated.

It has been recognized that a differential measurement may be applied to overcome the impact of the leakage current, the feedthrough, transistor offset, etc. on the ToF measurements by applying a subtraction of two opposite frames (frame A-frame B), for instance, a phase shift of 180° may be applied between the two frames.

It has further been recognized that a frame with only ambient light (no active light from a light source of the ToF device) may serve as a reference frame for one or more acquisitions with active light for subtracting the reference frame from the ToF measurement frames.

Hence, some embodiments pertain to a control for a time-of-flight device,
the time-of-flight device including a light source configured to emit a modulated light signal and a time-of-flight sensor including a plurality of time-of-flight circuitries, each time-of-flight circuitry being configured to generate an avalanche signal representing a light detection event and to sample a first and a second demodulation signal applied to a first and a second input node, respectively, based on the avalanche signal to generate a first and a second output voltage representing distance information, the first and the second demodulation signal being phase shifted by 90° with respect to each other,
wherein the control includes circuitry configured to:
control a timing of the first and second demodulation signal and a light emission of the light source; and
control the time-of-flight sensor to acquire a first and a second frame, each frame including a digital representation of the first and the second output voltage of at least a part of the plurality of time-of-flight circuitries, wherein the first and second demodulation signal or the modulated light signal is phase shifted by 180° between the first and the second frame.

Some embodiments pertain to a time-of-flight device, wherein the time-of-flight device includes:
a light source configured to emit a modulated light signal;
a time-of-flight sensor including a plurality of time-of-flight circuitries, each time-of-flight circuitry being configured to generate an avalanche signal representing a light detection event and to sample a first and a second demodulation signal applied to a first and a second input node, respectively, based on the avalanche signal to generate a first and a second output voltage, respectively, representing distance information, the first and the second demodulation signal being phase shifted by 90° with respect to each other; and
a control including circuitry configured to:
   control a timing of the first and second demodulation signal and a light emission of the light source; and
   control the time-of-flight sensor to acquire a first and a second frame, each frame including a digital representation of the first and the second output voltage of at least a part of the plurality of time-of-flight circuitries, wherein the first and second demodulation signal or the pulse-width modulated light signal is phase shifted by 180° between the first and the second frame.

In particular, some embodiments pertain to a time-of-flight device, wherein the time-of-flight device includes:
a light source configured to emit a modulated light signal;
a time-of-flight sensor including:
   a plurality of time-of-flight circuitries, each time-of-flight circuitry including:
      a SPAD circuit configured to generate an event upon detection of a photon,
      a switch control circuit configured to generate, in response to the generated event, a first signal for sampling a demodulation signal and a second signal for including the sample into an average output,
      a first averaging demodulator, which has a first demodulation voltage applied at its input node, configured to sample the first demodulation signal in response to the first signal and to include the sample in its output voltage in response to the second signal to generate a first output voltage,
      a second averaging demodulator, which has a second demodulation voltage applied at its input node, configured to sample the second demodulation signal in response to the first signal and to include the sample in its output voltage in response to the second signal to generate a second output voltage,
      wherein the first and the second demodulation signal are phase shifted by 90° with respect to each other; and
a control including circuitry configured to:
   control a timing of the first and second demodulation signal and a light emission of the light source,
   control the time-of-flight sensor to acquire a first and a second frame, each frame including a digital representation of the first and the second output voltages of at least a part of the plurality of time-of-flight circuitries, wherein the first and second demodulation signal or the modulated light signal is phase shifted by 180° between the first and the second frame.

In the following “ToF” is used as abbreviation for “time-of-flight”.

The light source may be a LED (Light Emitting Diode), a laser diode, an array of LEDs, an array of laser diodes, or the like.

The light source may include optical parts such as lenses, filters, etc. to spatially shape the emitted light, for example, the modulated light signal may be spatially shaped such that it includes a plurality of high intensity areas (e.g., dots, stripes, etc.) and a plurality of low intensity areas between the high intensity areas or it may have a Gaussian-shaped spatial intensity distribution.

The modulated light signal is temporally modulated including time periods with high and low output power. The modulated light signal is a periodic signal with a modulation frequency fmod (inverse of the time period with which the light signal is repeated, which may also be referred to as ToF measurement time period Tmod), for example, the modulated light signal may be a sine, a cosine, a pulsed width modulated signal, a rectangular signal, a triangular signal, or the like.

The first and second demodulation signal are periodic electric signals with the same demodulation frequency. The demodulation frequency fdemod is the same as the modulation frequency of the modulated light signal. The first and second demodulation signal may be a sine, a cosine, a pulsed width modulated signal, a rectangular signal, a triangular signal, or the like.

However, the first and the second demodulation signals are phase shifted by 90° with respect to each other, for example, the first demodulation signal is a sine, thus the second demodulation signal is a cosine.

The circuitry may be based on or may include or may be implemented as integrated circuitry logic or may be implemented by a CPU (central processing unit), an application processor, a graphical processing unit (GPU), a microcontroller, an FPGA (field programmable gate array), an ASIC (application specific integrated circuit) or the like or a combination thereof.

The functionality may be implemented by software executed by a processor such as a microprocessor or the like. The circuitry may be based on or may include or may be implemented by typical electronic components configured to achieve the functionality as described herein. The circuitry may be based on or may include or may be implemented in parts by typical electronic components and integrated circuitry logic and in parts by software.

The circuitry may include data storage capabilities to store data such as memory which may be based on semiconductor storage technology (e.g., RAM, EPROM, etc.) or magnetic storage technology (e.g., a hard disk drive) or the like.

The circuitry may include a data bus for receiving and transmitting data over the data bus. The circuitry may implement communication protocols for receiving and transmitting the data over the data bus.

The control may be a separate device or may be part of the light source or the ToF sensor.

Generally, the control controls performing a ToF measurement using the light source and the ToF sensor, wherein the control synchronizes light emission and data acquisition.

Hence, the control controls a timing of the first and second demodulation signal and a light emission of the light source.

The control may thus transmit control signals to the light source and the ToF sensor indicating the start of a ToF measurement, the applied phase shift, the (de)modulation frequency, the ToF circuitries (pixel) which are used in the ToF measurement, etc.

It has been recognized that the differential measurement may be performed in time.

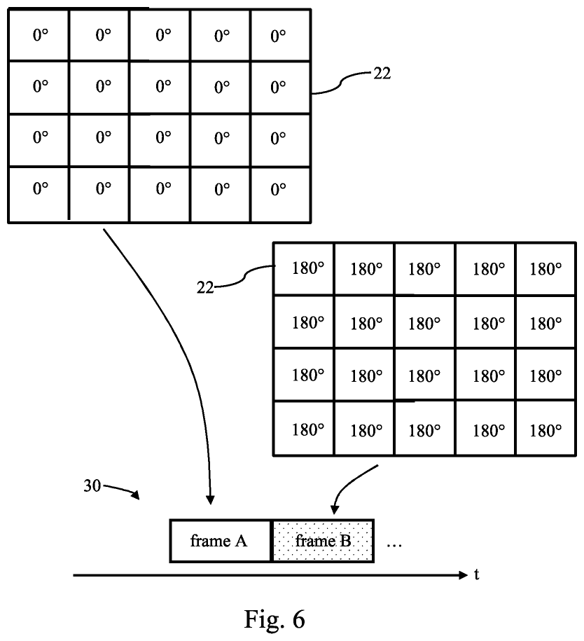

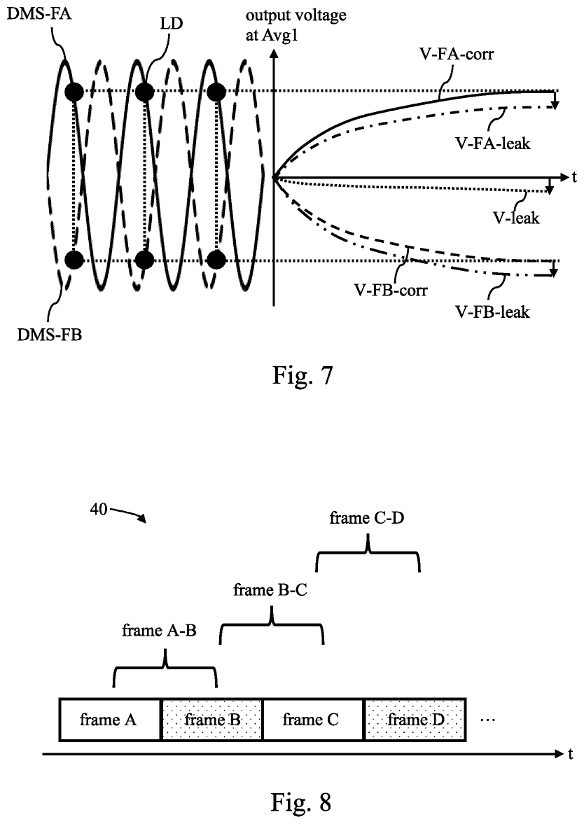

Hence, in some embodiments, the second frame is acquired subsequent to the first frame, as will be discussed under reference of FIGS. 6 and 7 and, for the phase shifting of the modulated light signal, under reference of FIG. 10.

In some embodiments, first frames and second frames are acquired in an alternating sequence in time, as will be discussed under reference of FIG. 8.

In some embodiments, the circuitry is configured to obtain the distance information based on a first frame and a subsequent second frame or based on a second frame and a subsequent first frame, as will be discussed under reference of FIG. 8.

It has been recognized that the leakage current is typically the same for a measurement with and without active light emission.

Thus, as mentioned above, it has been recognized that a reference frame with ambient light and no active light emission may be acquired for one or more subsequent frames with active light emission.

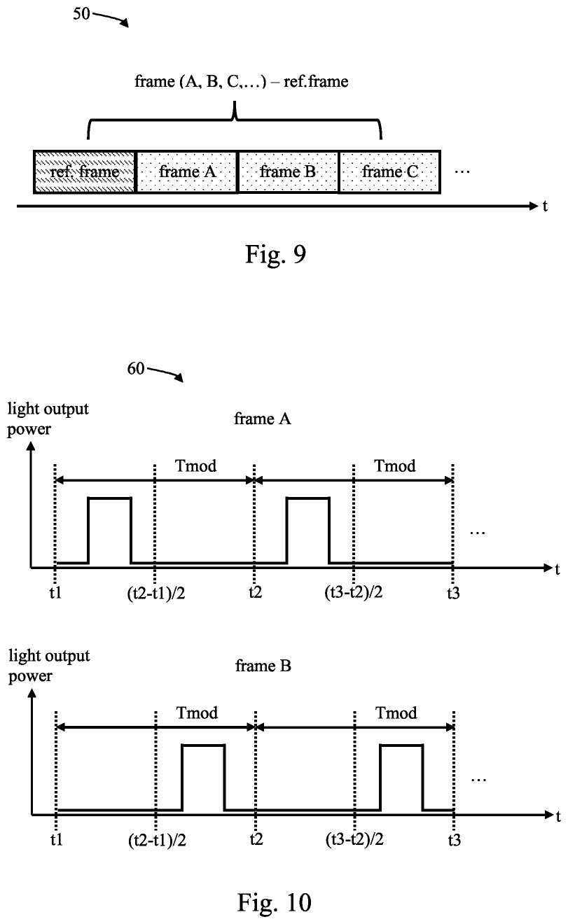

In some embodiments, the first and second demodulation signal is phase shifted by 180° between the first and the second frame, wherein the light source is controlled to not emit light during acquisition of the first frame, as will be discussed under reference of FIG. 9.

Typically, the non-idealities are pixel-based (intra pixel), however, an estimation may be obtained from neighboring pixels. Moreover, some inter pixel-based non-idealities may be present which can be accounted for by performing the differential measurement in space by simultaneously acquiring two frames with different phase shift.

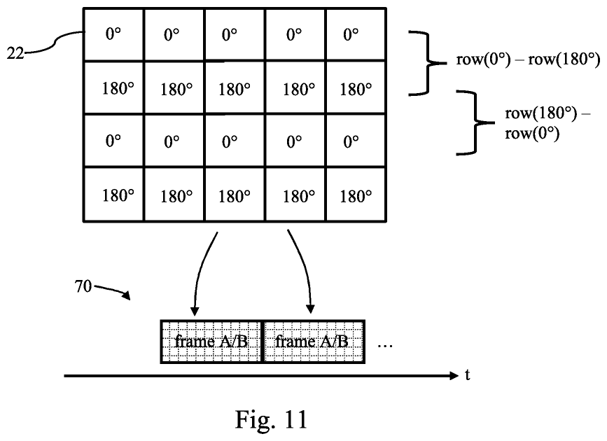

Thus, in some embodiments, the plurality of time-of-flight circuitries is arranged in rows and columns, wherein the first frame is acquired in first rows and the second frame is acquired simultaneously in second rows, wherein the first and the second rows are arranged in an alternating manner, as will be discussed under reference of FIG. 11.

In some embodiments, the circuitry is configured to obtain the distance information based on the first and the second frame.

Some embodiments pertain to a (corresponding) control method for a time-of-flight device,
the time-of-flight device including a light source configured to emit a modulated light signal and a time-of-flight sensor including a plurality of time-of-flight circuitries, each time-of-flight circuitry being configured to generate an avalanche signal representing a light detection event and to sample a first and a second demodulation signal applied to a first and a second input node, respectively, based on the avalanche signal to generate a first and a second output voltage representing distance information, the first and the second demodulation signal being phase shifted by 90° with respect to each other,
wherein the control method includes:
controlling a timing of the first and second demodulation signal and a light emission of the light source; and
controlling the time-of-flight sensor to acquire a first and a second frame, each frame including a digital representation of the first and the second output voltage of at least a part of the plurality of time-of-flight circuitries, wherein the first and second demodulation signal or the modulated light signal is phase shifted by 180° between the first and the second frame.

The control method may be performed by the control as described herein.

The methods as described herein are also implemented in some embodiments as a computer program causing a computer and/or a processor to perform the method, when being carried out on the computer and/or processor. In some embodiments, also a non-transitory computer-readable recording medium is provided that stores therein a computer program product, which, when executed by a processor, such as the processor described above, causes the methods described herein to be performed.

Returning to FIG. 1, there is schematically illustrated in a block diagram an embodiment of a ToF device 1, which is discussed in the following under reference of FIGS. 1 to 5.

The ToF device 1 includes a light source 2, a control 3 and a ToF camera 4.

The light source 2 emits within a filed-of-illumination 5 a modulated light signal to a scene, wherein the modulated light signal is spatially shaped and has a high intensity areas 7 and low intensity areas 8.

The scene 6 includes an object 9 which at least partially reflects the modulated-light signal such that the ToF camera 4 images the reflected light, which is within a field-of-view 10, onto a ToF sensor (not shown) in the ToF camera 4.

The control 3 controls performing the ToF measurement by control signals indicating a start timing of light emission and data acquisition.

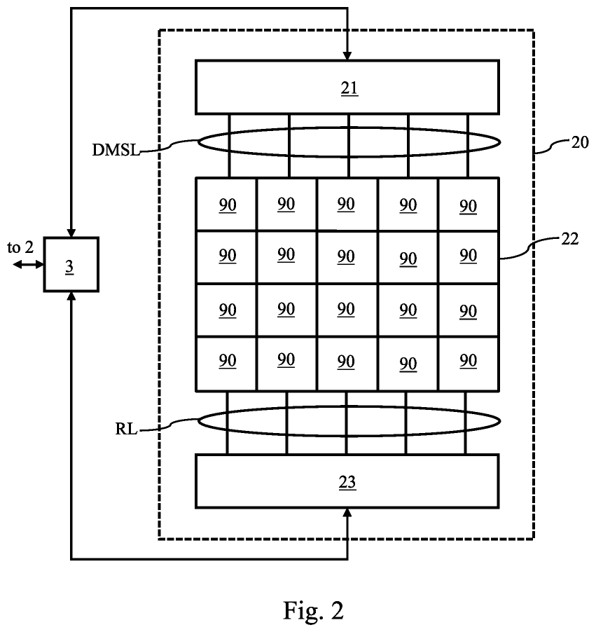

FIG. 2 schematically illustrates in a block diagram an embodiment of the ToF sensor 20, which is discussed in the following.

The ToF sensor 20 includes a demodulation driver 21, a ToF pixel array 22 including a plurality of ToF circuitries 90 arranged in rows and columns, and a readout circuit 23.

The control 3 transmits a control signal to the demodulation driver 21 and the readout circuit indicating a start timing of the data acquisition. The control signal may further indicate, for example, a frame duration, phases of the first and second demodulation signal, the demodulation frequency, and the ToF circuitries at which the demodulation signals are applied.

The demodulation driver 21 generates and applies, in accordance with the control signal, a first and second demodulation signal to a first and second input node (not shown), respectively, of the ToF circuitries 90 via a plurality of demodulation signal lines DMSL, wherein the first and the second demodulation signal are phase shifted by 90° with respect to each other.

Here, the first modulation signal is a sine and the second demodulation signal is a cosine.

Each of the plurality of ToF circuitries 90 generates an avalanche signal representing a light detection event and samples the first and the second demodulation signal applied to the first and the second input node, respectively, based on the avalanche signal to generate a first and a second output voltage representing distance information.

The readout circuit 23 reads each first and second output voltage via a plurality of readout lines RL and performs analog-to-digital conversion (ADC) to obtain a digital representation of each first and second output voltage.

At least the digital representations together with corresponding pixel positions form a frame which is acquired by the ToF sensor 22 under the control of the control 3.

The ToF sensor 22 outputs the frame to the control 3 once acquired.

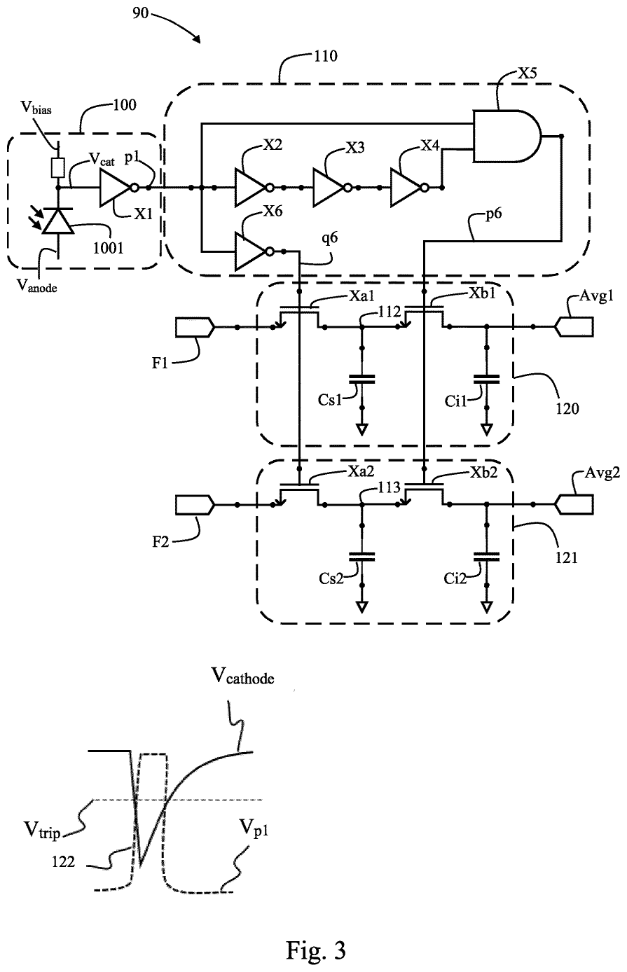

FIG. 3 schematically illustrates an embodiment of ToF circuitry (a TOF receiver) 90 with a SPAD circuit 100, a switch control circuit 110 and two averaging demodulators 120 and 121 driven by the switch control circuit 110, which is discussed in the following.

As mentioned above, other ToF circuitries (ToF receiver) of the International patent application publication WO 2022043480 A1 may be used in some embodiments.

The SPAD circuit 100 generates an event upon detection of a photon.

The switch control circuit 110 generates, in response to the generated event, a first signal for sampling a demodulation signal and a second signal for including the sample into an average output.

The first averaging demodulator 120, which has a first demodulation voltage applied at its input node F1, samples the first demodulation signal in response to the first signal and includes the sample in its output voltage in response to the second signal to generate a first output voltage.

The second averaging demodulator 121, which has a second demodulation voltage applied at its input node F2, samples the second demodulation signal in response to the first signal and includes the sample in its output voltage in response to the second signal to generate a second output voltage.

The ToF circuitry 90 will be discussed in more detail in the following.

The SPAD circuit 100 includes at least a detector adapted to generate a pulse Vcat which is representative of a voltage on a node of a cathode of a SPAD 1001 (single photon avalanche detector) in response to an incident photon on the SPAD 1001.

Generally, a solution is to use a SPAD detector, which may be implemented as an avalanche photodetector (ADP) that is biased above a breakdown voltage by applying voltages on nodes Vbias and Vanode having a voltage difference larger than the breakdown voltage of the SPAD 1001. As an example, which is implemented in this embodiment, for the SPAD 1001 operating with a break-down voltage of twenty-one volts, the voltage on node Vbias can be three volts, and that of node Vanode minus twenty volts, totaling twenty-three volts over the SPAD when no current is flowing. The excess bias voltage is then two volts. When a photon is incident that gets detected (for example, not all photons may get detected, in some embodiments) a negative pulse Vcathode on a cathode of the SPAD 1001 will occur bringing the voltage over the SPAD detector below or at breakdown (in the example from three volts to one volt).

The circuit shown inside the SPAD circuit 100, has also an inverter X1 with tripping level Vtrip for making a digital output on node p1. An output signal Vp1 (as shown in the lower part of FIG. 3) is a positive pulse on the node p1 and to a positive edge of a signal 122 it will further be referred to as an event (which is a light detection event as referred to in this disclosure).

In some embodiments, more complex circuits can be integrated into the SPAD circuit 100, e.g., including but not limited to, having a functionality of auto-quenching, pulse shaping and/or modulation of the detector biasing. All that is needed for the operation of ToF circuitry according to the present disclosure in some embodiments is to have a rising output edge 122 on p1 that is indicative for the time of a photon being incident on the SPAD 1001. Throughout the description of embodiments, an event concerns this rising edge 122 on p1, however in practice a negative edge could alternatively also be defined as the event, if preferred, as will be appreciated by a person skilled in the art. Moreover, generally, the present disclosure is not limited to the concept of rising or falling edge of a pulse, but, for instance, a peak detection of a signal may also be referred to as a (light detection) event (only to mention a further example and without limiting the present disclosure in that regard).

The SPAD 1001 will further have dark counts, as generally known: these are spontaneous events due to dark current that may also generate similar edges. However, these edges will happen typically at random moments in time and are therefore obscuring the events originating from incident photons. The rate at which these events happen is called the Dark Count Rate (DCR). In some embodiments of the present disclosure, a rising edge 122 at the output of the SPAD circuit 100 indicates an event, be it originating from a photon or from a DCR event. A falling edge of the pulse Vp1 on node p1 may be considered less informative and may come a variable time after the rising edge 122, being dependent on implementation of specific elements of the SPAD circuit 100. This pulse, with its timing information being indicated in the rising edge 122, is passed-on to the switch control circuit 110 through the voltage Vp1 on node p1.

In some embodiments, the SPAD Circuit 100 could also contain an avalanche photodetector (APD) that is biased below breakdown and having such an inherent high gain that a similar digital pulse can be constructed on the digital output node p1, also generating an rising output edge 122 on p1 that is indicative for the time of arrival of a photon.

The switch control circuit 110 of the present embodiment outputs two signals. A different circuitry may be used to implement the switch control circuit 110 in other embodiments. A first signal on a node q6 is provided for driving switches Xa1 and Xa2 (being implemented as transistors in this embodiment) in the attached averaging demodulators 120 and 121, for sampling on nodes 112 and 113 (roughly) synchronously with demodulation voltages applied at inputs F1 and F2 of the averaging demodulators 120 and 121, respectively, at each event. A second signal on a node p6 is a signal for driving switches Xb1 and Xb2 that causes that the sampled voltages on nodes 112 and 113 get accounted for in an output average voltage on output nodes Avg1 and Avg2 of the averaging demodulators 120 and 121, respectively, by making the switches Xb1 and Xb2 conductive after the sampling operation for a predetermined period of time. The sampled voltages on nodes F1 and F2 are stored on capacitors Cs1 and Cs2, and the averaged voltages are stored on capacitors Ci1 and Ci2, which are respectively coupled to the output nodes Avg1 and Avg2.

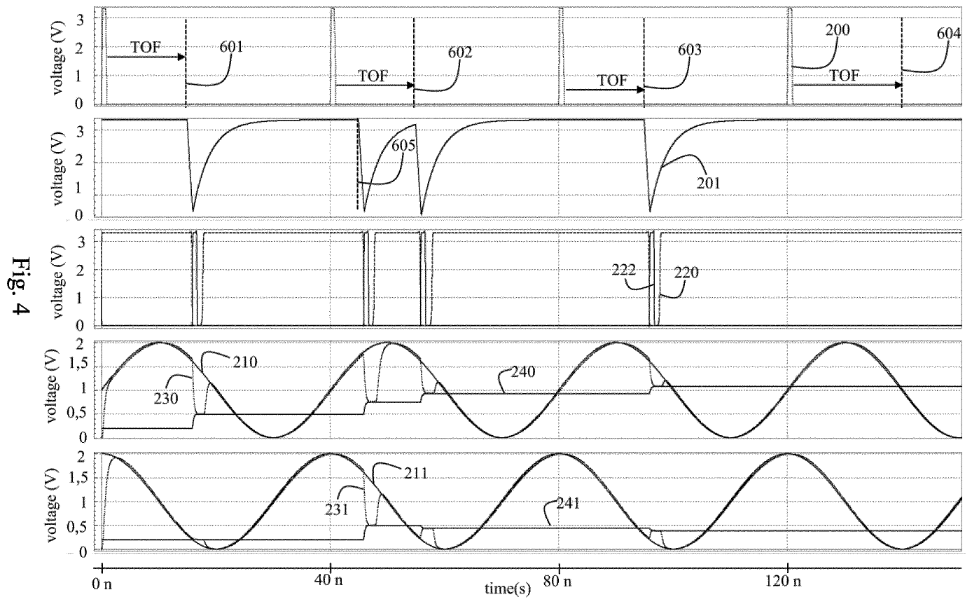

FIG. 4 schematically illustrates transient signals of an operation of the ToF circuitry 90 of FIG. 3, thereby demonstrating the use of sine and cosine demodulation signals.

In particular, FIG. 4 shows an operation based on a SPICE (Simulation program with integrated circuit emphasis) transient simulation. Curve 200 represents scene illumination light source pulses that are repeated every 40 ns, thus with a pulse repetition rate of 25 MHz in this embodiment.

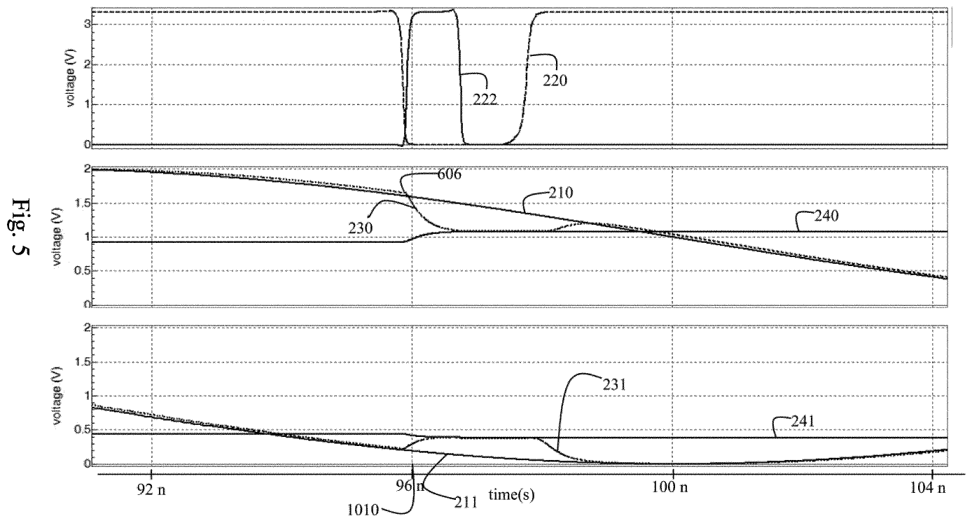

FIG. 5 schematically illustrates a zoom-in on some of the signals around the event at ninety-six nanoseconds of FIG. 4.

This light is pulse-wise illuminating the scene, and (some of) the reflected light will be received by the SPAD circuit 100. The scene illuminating light source can be of any type that can generate short light pulses, like LEDs or LASERs. With a delay represented by the time-of-flight (TOF), it becomes possible at moments 601, 602, 603 and 604 that events will be triggered as shown by a dip in a cathode voltage of the SPAD, curve 201. When an event is triggered due to a TOF photon, it is herein referred to as a TOF event. Further, since the reflected light from the scene may be very faint, only few photons may reach the SPAD circuit 100, and only a fraction of these may trigger a TOF event. Curve 201 shows only three events, at moments 601, 602 and 603 that are triggered after a TOF delay, and, thus, can be TOF events. At the fourth moment 604, there is no response in this example (although it might be expected). Further, there can be photons stemming from ambient light, or background light (BL) that can generate events at random times, if they are incident on the SPAD 1001, uncorrelated with the timing of the emitted light pulses 200. Also, the SPAD circuit 100 may generate dark count rate (DCR) events, also at random times. At moment 605, an event occurs, of which one can't tell whether it originates from BL or from DCR.

In the example of FIG. 4, the demodulation functions are based on sine and cosine voltages 210 and 211 which are applied on the inputs F1 and F2 of the averaging demodulators 120 and 121, respectively. To keep it in a single power supply voltage domain, the sine and cosine voltages have a positive one volt offset and they have an amplitude of one volt (in other words: they both oscillate between 0 and 2V) (without limiting the present disclosure in that regard).

At every event, the switch control circuit 100 causes the voltage on node q6 to go low for a predetermined period of time. Until then, the signals 230 and 231 follow their respective voltages on nodes F1 and F2, curves 210 and 211.

In response to each event, q6 goes low, and the switches Xa1 and Xa2 stop to conduct, leaving the voltages on nodes 112 and 113 stay at their last value. Switch control circuit 100 then causes the node voltage p6 to temporarily go high, after the signal q6 went low. There can be a time period between the going low of q6 and the going high of p6, the voltage sample will stay on nodes 112 and 113. In the example of FIG. 4 (and FIG. 5 that is a zoom in around the event around 95 ns), there is very little time present in-between these edges in this embodiment, which may be considered as not required in other embodiments).

During the period that p6 is high, there is an intended short-circuit between the capacitors Cs1 and Ci1 and between Cs2 and Ci2 due to the conduction of the switches Xb1 and Xb2 of the averaging demodulators 120 and 121, respectively.

The explanation of the operation of the averaging demodulators will be focused on the first one (averaging demodulator 120). Same understanding applies to other ones of the present disclosure, wherein potential modifications may be apparent to the person skilled in the art.

By shorting Cs1 with Ci1, the voltages on these capacitors will move towards each other, and find a common voltage depending on the capacitor ratio Ci1/Cs1. The averaging capacitor Ci1 is assumed larger to much larger, than the sampling capacitor Cs1. If the ratio is a factor of 100, when the short-circuiting happens between both, the voltage on the larger capacitor will move by about 1% towards that of the small capacitor, and the small capacitor's voltage will move for about 99% towards the larger one. Therefore, in the new average voltage on node Avg1, the latest event is taken into account for by 1%, and the history remains present for by 99%. It is possible to define a sample averaging length n as the capacitor ratio n=Ci1/Cs1. This would deliver with n equals a hundred (i.e., the capacitor ration equals a hundred) an effect of the latest hundred samples that are roughly taken into account. Hence, a more recent sample counts for 1%, whilst a sample that was sampled 99 samples ago, is accounted for, with a much smaller weight.

For illustration purposes in the simulation of FIGS. 4 and 5, a capacitor ratio of four is chosen, such that there is a sample averaging length of n equals four (without limiting the present disclosure in that regard). Just before ninety-six nanoseconds (which is marked with reference number 1010), in FIG. 5, at 606, voltage 230 on node 112 that was following the voltage 210 from node F1, stops following because voltage 220 on node q6 drops, and switch Xa1 stops conducting. Voltage 222 on node p6 then goes high, pulling voltages 230 and 240 (being the voltage on the capacitors Cs1 and Ci1), towards each other in accordance to their respective capacitive values. The high level 222 on node p6 lasts sufficiently long and goes low again dictated by the switch control circuit 100. The output voltage 240 on node Avg1 is then updated with the latest event data with a weight determined by the averaging length n.

At a later point of time, a signal 220 on node q6 goes high again, preparing for a next event to occur.

Alternative embodiments may be envisaged in which there is more than one switch between node F1 and node 112. In some embodiments, additionally or alternatively, there is more than one switch between node 112 and node Avg1.

Generally, a voltage sample is taken from the demodulation function present on node F1 onto a node 112 with a capacitance Cs1 in the response of an event, and thereafter charge-sharing with a larger capacitor Ci1 is performed by making a conductive path between the two capacitors (between nodes 112 and node Avg1).

This method of operation provides that sampling occurs at the rate of the events that are coming in.

In the embodiment which is described with respect to FIGS. 3 to 5, a time-of-flight device (or receiver) with time-of-flight circuitry described herein may be operated in extreme conditions: e.g. to average out only very few number of events (e.g. every ten microseconds an event) over extreme long periods (e.g. for over one to ten milliseconds), or to average out many events (e.g. every twenty nanoseconds an event) over extreme short periods (e.g. during microseconds).

A TOF receiver 90 according to the present disclosure may be able to operate independently, i.e. without the need of external support since it may work close to optimal. Inherent high dynamic range (HDR) can be achieved.

The switches in the averaging demodulator 120 are NMOS pass-gates Xa1 and Xb1. In some embodiments, they are implemented as full-fledged CMOS switches with both NMOS and PMOS transistors conducting at (roughly) the same moment, or just only PMOS pass-gates (in other embodiments). Further, in order to achieve a large sample averaging length n, capacitor Cs1 can be constructed merely by a parasitic capacitance of the diffusion nodes of the connected switches Xa1 and Xb1. Further, it may be envisaged to provide Cs1 as being settable, e.g., by using a varactor, or a switch which is configured to add an additional capacitor in parallel to it. In that way, the sample averaging length n can be made settable and variable. The output averaging capacitor Ci1 may be provided in the way that is most suitable to the used chip technology, e.g., by gate capacitance, poly-poly, metal fingered, or by a capacitor that is available for implementation of a dynamic memory (e.g., metal filled trench).

Aforementioned considerations hold for the second averaging demodulator 121 with the cosine voltage at its input F2, and for all other averaging demodulators of the present disclosure. However, the present disclosure is not limited that averaging demodulators of the same embodiment of a time-of-flight circuitry are necessary envisaged to be copies of each other since every averaging demodulator may be provided individually, depending on the circumstances.

The switch control circuit 110 contains an inverter X6, as an example, to provide signal q6. The components X2, X3, X4 and X5 of FIG. 1 constitute a one-shot circuit: at the occurrence of an event, p1 goes high, and for a period of the latency of three inverters (X2, X3 and X4), p4 remains high during which the output p6 of a NAND-gate X5 gets high for about that latency period, however, long enough to fulfill said charge sharing between nodes 112 and Avg1.

The switch control circuit 110 is just an example circuit, but many other circuits can achieve same or similar functionality, e.g., optimized for size but not limited thereto. In this embodiment, signals q6 and p6 should be constructed to never be high at the same time, i.e., they should be non-overlapping signals to avoid that switches Xa1 and Xb1 get conductive simultaneously thereby corrupting the output voltage on node Avg1.

In order to measure a distance based on TOF, in the case of having also BL and DCR, two measurements based on averaging demodulation may be needed. In FIG. 3 this is done in a simultaneous way, having per time-of-flight circuitry 90 two averaging demodulators 120 and 121 available.

In the following, some embodiments pertaining to mitigating the impact of non-idealities and common mode (ambient light contribution) on the ToF measurement are discussed.

FIG. 6 schematically illustrates an embodiment of a ToF measurement sequence 30, which is discussed in the following.

The control 3 controls the light source 2 and the ToF sensor 22 to perform the ToF measurement sequence 30.

The ToF measurement sequence 30 includes acquisition of a first frame (frame A) and a second frame.

In the acquisition of frame A, the first demodulation signal (applied to input nodes F1 of FIG. 3) has a phase of 0° with respect to a start timing of a ToF measurement period (e.g., a sine) and the second demodulation signal (applied to input nodes F2 of FIG. 3) has a phase shift of 90° (e.g., a cosine) with respect to the first demodulation signal.

In the acquisition of frame B, the first and the second demodulation signal (applied to input nodes F1 and F2 of FIG. 3) are phase shifted by 180° with respect to the first and second demodulation signal in frame A, respectively. However, the second demodulation signal may not be phase shifted by 180° with respect to the second demodulation signal in frame A in other embodiments.

The ToF measurement sequence 30 may be repeated several times.

Hence, in the acquisition of frame A, the first demodulation signal has a phase of 0° with respect to a start timing of a ToF measurement period, as illustrated also by the upper ToF pixel array 22 in which the phase of the first demodulation signal is shown for each ToF circuitry 90 of FIG. 2.

Hence, in the acquisition of frame B, the first demodulation signal is phase shifted by 180° with respect to the first demodulation signal in frame A, as illustrated also by the lower ToF pixel array 22 in which the phase of the first demodulation signal is shown for each ToF circuitry 90 of FIG. 2.

The modulated light signal emitted by the light source 2 has the same phase in frame A and frame B, which may be 0° with respect to a start timing of a ToF measurement period.

The control 3 (see FIGS. 1 and 2) obtains the distance information as follows in which the effect of the non-idealities is mitigated.

Generally, the first output voltage at node Avg1 (see FIG. 3) represents a quadrature component Q and the second output voltage at node Avg2 (see FIG. 3) represents an in-phase component I which are together known as IQ values for a pixel (ToF circuitry 90) in ToF.

As mentioned above, the first and second output voltage have 1V offset voltage (without limiting the disclosure in this regard) applied such that the Q and I values are given by:

Q=voltage at node Avg1−offset voltage,

I=voltage at node Avg2−offset voltage.

The distance information d is obtained from the phase P which is given by:

$$P = arctan ( \frac{Q}{I} ) ,$$

$$d = \frac{c}{2} \cdot \frac{P}{2 π \cdot fdemod} .$$

Here, d is the distance for a given pixel and fdemod the demodulation frequency of the first and second demodulation signals (which is the same as the modulation frequency of the modulated light signal).

However, the IQ values for a single ToF measurement (e.g., with phases of 0° and 90° of the first and the second demodulation signal, respectively) include the non-idealities, in particular the leakage current, transistor offsets, etc. . . . .

These contributions are eliminated when the IQ values in frame A and frame B are subtracted from each other, as will be discussed in the following under reference of FIG. 7.

FIG. 7 schematically illustrates an embodiment of an impact of a leakage current on a ToF measurement.

For the sake of illustration, the first output voltage at node Avg1 (Q value) is chosen, however, the effect is similar for the second output voltage at node Avg2 (I value).

On the right side, several voltages (vertical axis) are plotted over time (horizontal axis), in particular over three ToF measurement time periods.

On the left side, the first demodulation signal DMS-FA (solid line on left side) during frame A at node F1 and the first demodulation signal DMS-FB (long dashed line on left side) during frame B at node F1 are shown over three periods (ToF measurement time periods). The DMS-FB is phase shifted by 180° with respect to DMS-FA.

Moreover, the left side shows a light detection event LD (filled dot on left side) which is due to active light emission of the light source 2 at the beginning of each period of DMS-FA and DMS-FB and the round-trip time required to reach an object, to be reflected at the object and to reach the ToF sensor 22 (any pixel/ToF circuitry 90).

Thus, the LD occurs ideally at the same phase value of DMS-FA and DMS-FB in each period.

Accordingly, the output voltage V-FA-corr (solid line on right side) in frame A and V-FB-corr (dashed line on right side) in frame B would converge to the voltage of DMS-FA and DMS-FB, respectively, which is present at node F1 at the time when the LD is generated, as illustrated by the dotted horizontal lines.

However, due to the leakage current resulting in a voltage contribution V-leak (dotted line on right side), the output voltages V-FA-corr in frame A and V-FB-corr in frame B are reduced by V-leak such that the measured voltages are given by V-FA-leak (dashed dotted line) and V-FB-leak (dashed double dotted line), respectively.

As the output voltages V-FA-corr and V-FB-corr have the opposite sign but V-leak has the same sign in each frame, it has been recognized that the IQ values in frame A and frame B should be subtracted from each other to get rid of the leakage current or other imperfections contribution.

Returning to FIG. 6, thus, the control 3 calculates (based on the digital representations of the IQ values of each frame):

$$Q - corr = {Q}_{FA} - {Q}_{FB} ,$$

$$I - corr = {I}_{FA} - {I}_{FB} ,$$

Here, Q_{FA} is the (digitalized) first output voltage in frame A, Q_{FB} is the (digitalized) first output voltage in frame B, I_{FA} is the (digitalized) second output voltage in frame A and I_{FB} is the (digitalized) second output voltage in frame B.

Accordingly, the ToF measurement sequence 30 allows to mitigate the effect of a leakage current contribution on a ToF measurement by subtracting frame B from frame A.

FIG. 8 schematically illustrates an embodiment of a ToF measurement sequence 40, which is discussed in the following.

The control 3 controls the light source 2 and the ToF sensor 22 to perform the ToF measurement sequence 40.

The ToF measurement sequence 40 includes acquisition of a frame A, a frame B, a frame C and a frame D which may be repeated several times.

In the acquisition of frame A, the first demodulation signal (applied to input nodes F1 of FIG. 3) has a phase of 0° with respect to a start timing of a ToF measurement period (e.g., a sine) and the second demodulation signal (applied to input nodes F2 of FIG. 3) has a phase shift of 90° (e.g., a cosine) with respect to the first demodulation signal.

In the acquisition of frame B, the first and the second demodulation signal (applied to input nodes F1 of FIG. 3) are phase shifted by 180° (e.g., a-sine) with respect to the first and second demodulation signal in frame A, respectively. However, the second demodulation signal may not be phase shifted by 180° with respect to the second demodulation signal in frame A in other embodiments.

In the acquisition of frame C, the first demodulation signal (applied to input nodes F1 of FIG. 3) has a phase of 0° with respect to a start timing of a ToF measurement period (e.g., a sine) and the second demodulation signal (applied to input nodes F2 of FIG. 3) has a phase shift of 90° (e.g., a cosine) with respect to the first demodulation signal.

In the acquisition of frame D, the first and the second demodulation signal (applied to input nodes F1 of FIG. 3) are phase shifted by 180° (e.g., a-sine) with respect to the first and second demodulation signal in frame A, respectively. However, the second demodulation signal may not be phase shifted by 180° with respect to the second demodulation signal in frame A in other embodiments.

Hence, first frames including frame A and frame C and second frames including frame B and frame D are acquired in an alternating sequence in time.

The control 3 obtains the distance information without eliminated non-ideal effects due to a leakage current contribution based on a first frame and a subsequent second frame or based on a second frame and a subsequent first frame.

Here, the IQ values are based on the differences frame A-B, frame B-C and frame C-D and so on.

FIG. 9 schematically illustrates an embodiment of a ToF measurement sequence 50, which is discussed in the following.

As mentioned in the general explanations, it has been recognized that the leakage current is typically the same for a measurement with and without active light emission.

Thus, it has been recognized that a reference frame with ambient light and no active light emission may be acquired for one or more subsequent frames with active light emission.

The control 3 controls the light source 2 and the ToF sensor 22 to perform the ToF measurement sequence 50.

The ToF measurement sequence 50 includes acquisition of a reference frame, a frame A, a frame B and a frame C which may be repeated several times.

In the acquisition of the reference frame, the control 3 controls the light source 2 not to emit light. Moreover, the first demodulation signal (applied to input nodes F1 of FIG. 3) has a phase of 0° with respect to a start timing of a ToF measurement period (e.g., a sine) and the second demodulation signal (applied to input nodes F2 of FIG. 3) has a phase shift of 90° (e.g., a cosine) with respect to the first demodulation signal. Thus, the leakage current contribution on the first and second output voltages are acquired.

In the acquisition of frame A, B and C, the first and the second demodulation signal (applied to input nodes F1 and F2 of FIG. 3) are not to be phase shifted by 180° with respect to the first and second demodulation signal in the reference frame, respectively. However, in other embodiments, in the acquisition of frame A, B and C, the first and the second demodulation signal (applied to input nodes F1 and F2 of FIG. 3) may be phase shifted by 180° with respect to the first and the second demodulation signal in the reference frame.

The control 3 obtains the distance information without eliminated non-ideal effects due to a leakage current contribution based on IQ values obtained by the differences frame(A, B, C, . . . )−reference frame.

After frame C, the reference frame may be refreshed for the next one or more measurement frames.

In some embodiments, a frame duration of the reference frame is smaller than a frame duration of the measurement frames A, B and C (e.g., a tenth of it).

FIG. 10 schematically illustrates an embodiment of a ToF measurement sequence 60, which is discussed in the following.

The control 3 controls the light source 2 and the ToF sensor 22 to perform the ToF measurement sequence 60.

The ToF measurement sequence 60 includes acquisition of a frame A and a frame B which may be repeated several times.

In contrast to the ToF measurement sequences 30, 40 and 50 above, in which the first and second demodulation signals are phase shifted in different frames, the modulated light signal is phase shifted here.

The upper graph shows the light output power of the modulated light signal in time during acquisition of a first frame (frame A).

At t1, a first ToF measurement period is started (e.g., the control 3 triggers the start of the acquisition) which lasts for Tmod until t2. The ToF measurement time period is the same as the ToF demodulation time period of the demodulation signals (the inverse of the demodulation frequency). At t2, a second ToF measurement period is started which lasts for Tmode until t3.

Moreover, in the acquisition of frame A, the first demodulation signal (applied to input nodes F1 of FIG. 3) has a phase of 0° with respect to a start timing of a ToF measurement period (e.g., a sine) and the second demodulation signal (applied to input nodes F2 of FIG. 3) has a phase shift of 90° (e.g., a cosine) with respect to the first demodulation signal.

The lower graph shows the light output power the modulated light signal in time during acquisition of a second frame (frame B).

At t1, a first ToF measurement period is started (e.g., the control 3 triggers the start of the acquisition) which lasts for Tmod until t2. The ToF measurement time period is the same as the ToF demodulation time period of the demodulation signals (the inverse of the demodulation frequency). At t2, a second ToF measurement period is started which lasts for Tmode until t3.

However, in the acquisition of frame B, the modulated light signal is phase shifted by 180° which corresponds to a time delay of Tmod/2.

Moreover, in the acquisition of frame B, the first demodulation signal (applied to input nodes F1 of FIG. 3) has a phase of 0° with respect to a start timing of a ToF measurement period (e.g., a sine) and the second demodulation signal (applied to input nodes F2 of FIG. 3) has a phase shift of 90° (e.g., a cosine) with respect to the first demodulation signal.

Thus, the phases of the first and second demodulation signal are the same as for frame A, however, the phase shift of 180° of the modulated light signal has the same effect as shifting the phase of the first and second demodulation signal by 180°.

Accordingly, the ToF measurement sequence 60 allows to mitigate the effect of a leakage current contribution on a ToF measurement by subtracting frame B from frame A.

FIG. 11 schematically illustrates an embodiment of a ToF measurement sequence 70, which is discussed in the following.

The control 3 controls the light source 2 and the ToF sensor 22 to perform the ToF measurement sequence 70.

The ToF measurement sequence 70 includes acquisition of a frame A/B which may be repeated several times.

In contrast to the ToF measurement sequences 30, 40, 50 and 60 above, in which the first and the second frame are acquired subsequently in time, the first frame (frame A) and the second frame (frame B) are acquired simultaneously on different subsets of the ToF circuitries 90 of the ToF sensor 22.

As mentioned in the general explanations, typically, the non-idealities are pixel-based (intra pixel), however, an estimation may be obtained from neighboring pixels. Moreover, some inter pixel-based non-idealities may be present which can be accounted for by performing the differential measurement in space by simultaneously acquiring two frames with different phase shift.

Thus, as illustrated in FIG. 11, the first frame (frame A) is acquired in first rows and the second frame (frame B) is acquired simultaneously in second rows, wherein the first and the second rows are arranged in an alternating manner.

Hence, in the acquisition of frame A/B, the first demodulation signal has a phase of 0° in the first rows and a phase of 180° in the second rows with respect to a start timing of a ToF measurement period, as illustrated by the ToF pixel array 22 in which the phases of the first demodulation signal are shown for each ToF circuitry 90 of FIG. 2. Moreover, the second demodulation signal has a phase of 90° with respect to a start timing of a ToF measurement period in the first rows and is phase shifted by 180° in the second rows with respect to the second demodulation signal in the first rows. However, the second demodulation signal may not be phase shifted by 180° with respect to the second demodulation signal in the first rows in other embodiments.

The control 3 obtains distance information based on differences of IQ values of neighboring rows.

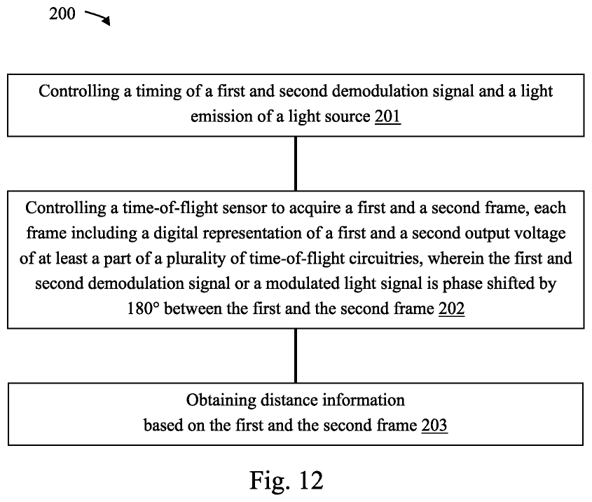

FIG. 12 schematically illustrates in a flow diagram an embodiment of a control method 200, which is discussed in the following.

The control method 200 may be performed by the control as described herein, e.g., by control 3 of FIGS. 1 and 2.

At 201, a timing of a first and second demodulation signal and a light emission of a light source is controlled, as discussed herein.

At 202, a time-of-flight sensor is controlled to acquire a first and a second frame, each frame including a digital representation of a first and a second output voltage of at least a part of a plurality of time-of-flight circuitries, wherein the first and second demodulation signal or a modulated light signal is phase shifted by 180° between the first and the second frame, as discussed herein.

At 203, distance information is obtained based on the first and the second frame, as discussed herein.

Returning to the general explanations, summing up some aspects of some embodiments:

Leakage current may have an impact on IQ values leading to an error in depth distance.

By using two frames per for obtaining the distance information, the final IQ values may evolve in the opposite way, i.e., the same amount of leakage current (voltage drop) is then sensed for the two frames (e.g., frame A and frame B) with a phase shift of 180°.

The subtraction of the information (phase) from opposite frames (e.g., frame A−frame B) and/or reference frame, may lead to cancel-out the total amount of leakage from the system and the other non-idealities. Only the main signal information may remain.

Differential measurement may lead to the cancelling of the common mode by eliminating the reference values. Other non-ideal effects of the switching cap system may be canceled by using this approach such as feedthrough, leakage impact, transistor offset, and other non-idealities of the system.

This may give a robustness to the concept of switch cap in the context of the described ToF devices independently of the technology choice (cap/transistor . . . ).

Average that is taken is leaking away (distance error) can be canceled by doing the double measurements.

It should be recognized that the embodiments describe methods with an exemplary ordering of method steps. The specific ordering of method steps is however given for illustrative purposes only and should not be construed as binding.

All units and entities described in this specification and claimed in the appended claims can, if not stated otherwise, be implemented as integrated circuit logic, for example on a chip, and functionality provided by such units and entities can, if not stated otherwise, be implemented by software.

In so far as the embodiments of the disclosure described above are implemented, at least in part, using software-controlled data processing apparatus, it will be appreciated that a computer program providing such software control and a transmission, storage or other medium by which such a computer program is provided are envisaged as aspects of the present disclosure.

Note that the present technology can also be configured as described below.
(1) A control for a time-of-flight device,
   the time-of-flight device including a light source configured to emit a modulated light signal and a time-of-flight sensor including a plurality of time-of-flight circuitries, each time-of-flight circuitry being configured to generate an avalanche signal representing a light detection event and to sample a first and a second demodulation signal applied to a first and a second input node, respectively, based on the avalanche signal to generate a first and a second output voltage representing distance information, the first and the second demodulation signal being phase shifted by 90° with respect to each other,
   wherein the control includes circuitry configured to:
   control a timing of the first and second demodulation signal and a light emission of the light source; and
   control the time-of-flight sensor to acquire a first and a second frame, each frame including a digital representation of the first and the second output voltage of at least a part of the plurality of time-of-flight circuitries, wherein the first and second demodulation signal or the modulated light signal is phase shifted by 180° between the first and the second frame.
(2) The control according of (1), wherein the second frame is acquired subsequent to the first frame.
(3) The control of (1) or (2), wherein first frames and second frames are acquired in an alternating sequence in time.
(4) The control of (3), wherein the circuitry is configured to obtain the distance information based on a first frame and a subsequent second frame or based on a second frame and a subsequent first frame.
(5) The control according of anyone of (1) to (4), wherein the first and second demodulation signal is phase shifted by 180° between the first and the second frame, wherein the light source is controlled to not emit light during acquisition of the first frame.
(6) The control of (1), wherein the plurality of time-of-flight circuitries is arranged in rows and columns, wherein the first frame is acquired in first rows and the second frame is acquired simultaneously in second rows, wherein the first and the second rows are arranged in an alternating manner.
(7) The control of anyone of (1) to (6), wherein the circuitry is configured to obtain the distance information based on the first and the second frame.
(8) A control method for a time-of-flight device,
   the time-of-flight device including a light source configured to emit a modulated light signal and a time-of-flight sensor including a plurality of time-of-flight circuitries, each time-of-flight circuitry being configured to generate an avalanche signal representing a light detection event and to sample a first and a second demodulation signal applied to a first and a second input node, respectively, based on the avalanche signal to generate a first and a second output voltage representing distance information, the first and the second demodulation signal being phase shifted by 90° with respect to each other,
   wherein the control method includes:
   controlling a timing of the first and second demodulation signal and a light emission of the light source; and
   controlling the time-of-flight sensor to acquire a first and a second frame, each frame including a digital representation of the first and the second output voltage of at least a part of the plurality of time-of-flight circuitries, wherein the first and second demodulation signal or the modulated light signal is phase shifted by 180° between the first and the second frame.
(9) The control method of (8), wherein the second frame is acquired subsequent to the first frame.
(10) The control method of (8) or (9), wherein first frames and second frames are acquired in an alternating sequence in time.
(11) The control method of (10), including obtaining the distance information based on a first frame and a subsequent second frame or based on a second frame and a subsequent first frame.
(12) The control method of anyone of (8) to (11), wherein the first and second demodulation signal is phase shifted by 180° between the first and the second frame, wherein the light source is controlled to not emit light during acquisition of the first frame.
(13) The control method of anyone of (8) to (12), including obtaining the distance information based on the first and the second frame.
(14) A time-of-flight device, including:
   a light source configured to emit a modulated light signal;
   a time-of-flight sensor including a plurality of time-of-flight circuitries, each time-of-flight circuitry being configured to generate an avalanche signal representing a light detection event and to sample a first and a second demodulation signal applied to a first and a second input node, respectively, based on the avalanche signal to generate a first and a second output voltage, respectively, representing distance information, the first and the second demodulation signal being phase shifted by 90° with respect to each other; and
   a control including circuitry configured to:
      control a timing of the first and second demodulation signal and a light emission of the light source; and
      control the time-of-flight sensor to acquire a first and a second frame, each frame including a digital representation of the first and the second output voltage of at least a part of the plurality of time-of-flight circuitries, wherein the first and second demodulation signal or the pulse-width modulated light signal is phase shifted by 180° between the first and the second frame.
(15) A time-of-flight device, including:
   a light source configured to emit a modulated light signal;
   a time-of-flight sensor including:
      a plurality of time-of-flight circuitries, each time-of-flight circuitry including:
         a SPAD circuit configured to generate an event upon detection of a photon,
         a switch control circuit configured to generate, in response to the generated event, a first signal for sampling a demodulation signal and a second signal for including the sample into an average output,
         a first averaging demodulator, which has a first demodulation voltage applied at its input node, configured to sample the first demodulation signal in response to the first signal and to include the sample in its output voltage in response to the second signal to generate a first output voltage,
         a second averaging demodulator, which has a second demodulation voltage applied at its input node, configured to sample the second demodulation signal in response to the first signal and to include the sample in its output voltage in response to the second signal to generate a second output voltage,
         wherein the first and the second demodulation signal are phase shifted by 90° with respect to each other; and
   a control including circuitry configured to:
      control a timing of the first and second demodulation signal and a light emission of the light source,
      control the time-of-flight sensor to acquire a first and a second frame, each frame including a digital representation of the first and the second output voltages of at least a part of the plurality of time-of-flight circuitries, wherein the first and second demodulation signal or the modulated light signal is phase shifted by 180° between the first and the second frame.
(16) The time-of-flight device of (15), wherein the second frame is acquired subsequent to the first frame.
(17) The time-of-flight device of (15) or (16), wherein first frames and second frames are acquired in an alternating sequence in time.
(18) The time-of-flight device of (17), wherein the circuitry is configured to obtain the distance information based on a first frame and a subsequent second frame or based on a second frame and a subsequent first frame.
(19) The time-of-flight device of anyone of (15) to (18), wherein the first and second demodulation signal is phase shifted by 180° between the first and the second frame, wherein the light source is controlled to not emit light during acquisition of the first frame.
(20) The time-of-flight device of anyone of (15) to (19), wherein the circuitry is configured to obtain the distance information based on the first and the second frame.
(21) A computer program comprising program code causing a computer to perform the method according to anyone of (8) to (13), when being carried out on a computer.
(22) A non-transitory computer-readable recording medium that stores therein a computer program product, which, when executed by a processor, causes the method according to anyone of (8) to (13) to be performed.

1. A control for a time-of-flight device,
the time-of-flight device including a light source configured to emit a modulated light signal and a time-of-flight sensor including a plurality of time-of-flight circuitries, each time-of-flight circuitry being configured to generate an avalanche signal representing a light detection event and to sample a first and a second demodulation signal applied to a first and a second input node, respectively, based on the avalanche signal to generate a first and a second output voltage representing distance information, the first and the second demodulation signal being phase shifted by 90° with respect to each other,
wherein the control comprises circuitry configured to:
control a timing of the first and second demodulation signal and a light emission of the light source; and
control the time-of-flight sensor to acquire a first and a second frame, each frame including a digital representation of the first and the second output voltage of at least a part of the plurality of time-of-flight circuitries, wherein the first and second demodulation signal or the modulated light signal is phase shifted by 180° between the first and the second frame.

2. The control according to claim 1, wherein the second frame is acquired subsequent to the first frame.

3. The control according to claim 1, wherein first frames and second frames are acquired in an alternating sequence in time.

4. The control according to claim 3, wherein the circuitry is configured to obtain the distance information based on a first frame and a subsequent second frame or based on a second frame and a subsequent first frame.

5. The control according to claim 1, wherein the first and second demodulation signal is phase shifted by 180° between the first and the second frame, wherein the light source is controlled to not emit light during acquisition of the first frame.

6. The control according to claim 1, wherein the plurality of time-of-flight circuitries is arranged in rows and columns, wherein the first frame is acquired in first rows and the second frame is acquired simultaneously in second rows, wherein the first and the second rows are arranged in an alternating manner.

7. The control according to claim 1, wherein the circuitry is configured to obtain the distance information based on the first and the second frame.

8. A control method for a time-of-flight device,
the time-of-flight device including a light source configured to emit a modulated light signal and a time-of-flight sensor including a plurality of time-of-flight circuitries, each time-of-flight circuitry being configured to generate an avalanche signal representing a light detection event and to sample a first and a second demodulation signal applied to a first and a second input node, respectively, based on the avalanche signal to generate a first and a second output voltage representing distance information, the first and the second demodulation signal being phase shifted by 90° with respect to each other,
wherein the control method comprises:
controlling a timing of the first and second demodulation signal and a light emission of the light source; and
controlling the time-of-flight sensor to acquire a first and a second frame, each frame including a digital representation of the first and the second output voltage of at least a part of the plurality of time-of-flight circuitries, wherein the first and second demodulation signal or the modulated light signal is phase shifted by 180° between the first and the second frame.

9. The control method according to claim 8, wherein the second frame is acquired subsequent to the first frame.

10. The control method according to claim 8, wherein first frames and second frames are acquired in an alternating sequence in time.

11. The control method according to claim 10, comprising obtaining the distance information based on a first frame and a subsequent second frame or based on a second frame and a subsequent first frame.

12. The control method according to claim 8, wherein the first and second demodulation signal is phase shifted by 180° between the first and the second frame, wherein the light source is controlled to not emit light during acquisition of the first frame.

13. The control method according to claim 8, comprising obtaining the distance information based on the first and the second frame.

14. A time-of-flight device, comprising:
a light source configured to emit a modulated light signal;
a time-of-flight sensor including a plurality of time-of-flight circuitries, each time-of-flight circuitry being configured to generate an avalanche signal representing a light detection event and to sample a first and a second demodulation signal applied to a first and a second input node, respectively, based on the avalanche signal to generate a first and a second output voltage, respectively, representing distance information, the first and the second demodulation signal being phase shifted by 90° with respect to each other; and
a control including circuitry configured to:
control a timing of the first and second demodulation signal and a light emission of the light source; and
control the time-of-flight sensor to acquire a first and a second frame, each frame including a digital representation of the first and the second output voltage of at least a part of the plurality of time-of-flight circuitries, wherein the first demodulation signal or the pulse-width modulated light signal is phase shifted by 180° between the first and the second frame.

15. A time-of-flight device, comprising:
a light source configured to emit a modulated light signal;
a time-of-flight sensor including:
a plurality of time-of-flight circuitries, each time-of-flight circuitry including:
a SPAD circuit configured to generate an event upon detection of a photon,
a switch control circuit configured to generate, in response to the generated event, a first signal for sampling a demodulation signal and a second signal for including the sample into an average output,
a first averaging demodulator, which has a first demodulation voltage applied at its input node, configured to sample the first demodulation signal in response to the first signal and to include the sample in its output voltage in response to the second signal to generate a first output voltage,
a second averaging demodulator, which has a second demodulation voltage applied at its input node, configured to sample the second demodulation signal in response to the first signal and to include the sample in its output voltage in response to the second signal to generate a second output voltage,
wherein the first and the second demodulation signal are phase shifted by 90° with respect to each other; and
a control including circuitry configured to:
control a timing of the first and second demodulation signal and a light emission of the light source,
control the time-of-flight sensor to acquire a first and a second frame, each frame including a digital representation of the first and the second output voltages of at least a part of the plurality of time-of-flight circuitries, wherein the first and second demodulation signal or the modulated light signal is phase shifted by 180° between the first and the second frame.

16. The time-of-flight device according to claim 15, wherein the second frame is acquired subsequent to the first frame.

17. The time-of-flight device according to claim 15, wherein first frames and second frames are acquired in an alternating sequence in time.

18. The time-of-flight device according to claim 17, wherein the circuitry is configured to obtain the distance information based on a first frame and a subsequent second frame or based on a second frame and a subsequent first frame.

19. The time-of-flight device according to claim 15, wherein the first and second demodulation signal is phase shifted by 180° between the first and the second frame, wherein the light source is controlled to not emit light during acquisition of the first frame.

20. The time-of-flight device according to claim 15, wherein the circuitry is configured to obtain the distance information based on the first and the second frame.
